(19) United States
(12) Patent Application Publication
(10) Pub. No.: US 2007/0294303 A1
(43) Pub. Date: Dec. 20, 2007

(54) SYSTEM AND METHOD FOR ACQUIRING MORTGAGE CUSTOMERS

(76) Inventors: Richard L. Harmon, Ann Arbor, MI (US); Afshin Goodarzi, Westport, CT (US)

Correspondence Address: Ketan S. Vakil;SNELL & WILMER L.L.P., Suite 1400, 600 Anton Boulevard, Costa Mesa, CA, 92626-7689, US

(21) Appl. No.: 11/765,355

(22) Filed: Jun. 19, 2007

Related U.S. Application Data
(60) Provisional application No. 60/815,022, filed on Jun. 20, 2006.

(51) Int. Cl. G06F 7/00

(52) U.S. Cl. 707/104.1

(57) ABSTRACT

One embodiment of the invention provides a machine-readable medium embodying a method of providing a list of individuals who are most likely to move, payoff or refinance their mortgages. The method includes receiving a name and an address from a customer database, retrieving demographic data corresponding to the name and the address from a demographic information database, and extrapolating property data corresponding to the name and the address from a property records database. The method also includes creating a plurality of records, each record including the name, the address, the demographic data and the property data, calculating a propensity score for each of the plurality of records, determining rules that relate to the propensity scores and applying the rules to each of the plurality of records to form a target list.

### CLAIM OF PRIORITY UNDER 35 U.S.C. §119

The present Application for Patent claims priority to Provisional Application No. 60/815,022 filed Jun. 20, 2006, and assigned to the assignee hereof and hereby expressly incorporated by reference herein.

### FIELD OF THE INVENTION

The invention relates generally to mortgage customers. More particularly, the invention relates to systems and methods for acquiring mortgage customers.

### DESCRIPTION OF THE RELATED ART

Many homeowners have a mortgage on their homes. Banks and lending institutions are constantly competing with one another to offer lower rates and better incentives to persuade homeowners to refinance their homes. Many different ways are current being used to market new loans to homeowners. For example, one commonly used method is to mail an offer with a very low “teaser” rate to thousands of homeowners. This is often referred to as a mass mailing. Mass mailings are ineffective as many homeowners throw away mortgage offers and treat them as junk mail.

Another commonly used method to market to homeowners is the Internet. Some banks and lending institutions resort to Internet advertising in an attempt to gain new mortgage customers. These Internet advertisements generally require the borrower to complete a loan application on the Internet. However, the process of completing a loan application on the Internet has several drawbacks. First, the loan application generally needs to be completed before a mortgage rate can be given to the borrower. Second, the process of completing a loan application requires a great deal of time. Third, many borrowers feel uncomfortable transmitting large amounts of confidential information over the Internet.

Mass marketing and Internet advertising are very expensive and generally leads to a small amount of business. Banks and lending institutions are trying to develop more effective ways of marketing to homeowners. One way is to determine when a homeowner is going to move, payoff or refinance their mortgage. However, it is very difficult to predict when a homeowner is going to move, payoff or refinance their mortgage. The difficulty becomes apparent by looking at the statistics, which show that over 75 percent of all refinancing transactions are performed by a new lender. If the bank or lending institution is fortunate enough to obtain the new loan, statistics show that the new loan amount generally increases by up to 30 percent. Therefore, it is increasing important to create a way to identify and target new customers that are about to move, payoff or refinance their mortgages.

### BRIEF DESCRIPTION OF THE DRAWINGS

FIG. 1 is a block diagram of a scoring system that calculates and outputs scores to assist marketing individuals in directed marketing efforts to acquire new mortgage customers according to an embodiment of the invention.

FIG. 2 is a flow chart of a method of determining and grouping individuals that are more likely to move, payoff or refinance their mortgages according to an embodiment of the invention.

FIG. 3 is a flow chart of a method of calculating a mover score, a payoff score and a refinance score according to an embodiment of the invention.

FIG. 4 is a graphical user interface that displays rules and allows the user to select the rules to obtain a desired group of individuals to target according to an embodiment of the invention.

FIG. 5 is a table of the pretell customer acquisition solution according to an embodiment of the invention.

FIG. 6 is a table showing that the deciles shown in FIG. 5 with the highest scores have the highest propensity to move, payoff or refinance their loans according to an embodiment of the invention.

FIG. 7 is a menu listing various product types according to an embodiment of the invention.

### SUMMARY

One embodiment of the invention provides a machine-readable medium embodying a method of providing a list of individuals who are most likely to move, payoff or refinance their mortgages. The method includes receiving a name and an address from a customer database, retrieving demographic data corresponding to the name and the address from a demographic information database, and extrapolating property data corresponding to the name and the address from a property records database. The method also includes creating a plurality of records, each record including the name, the address, the demographic data and the property data, calculating a propensity score for each of the plurality of records, determining rules that relate to the propensity scores and applying the rules to each of the plurality of records to form a target list.

One embodiment of the invention provides an apparatus for providing a list of individuals who are most likely to move, payoff or refinance their mortgages. The apparatus includes a database for storing demographic data, customer data and property data, and a data matching and appending module for receiving a name and an address from the database, retrieving demographic data corresponding to the name and the address from the database, extrapolating property data corresponding to the name and the address from the database, and creating a plurality of records, each record including the name, the address, the demographic data and the property data. The apparatus also includes a scoring module for calculating a propensity score for each record, a rules module for determining rules that relate to the propensity scores, and a group module for applying the rules to each record to form a target list.

### DETAILED DESCRIPTION

Systems and methods that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements.

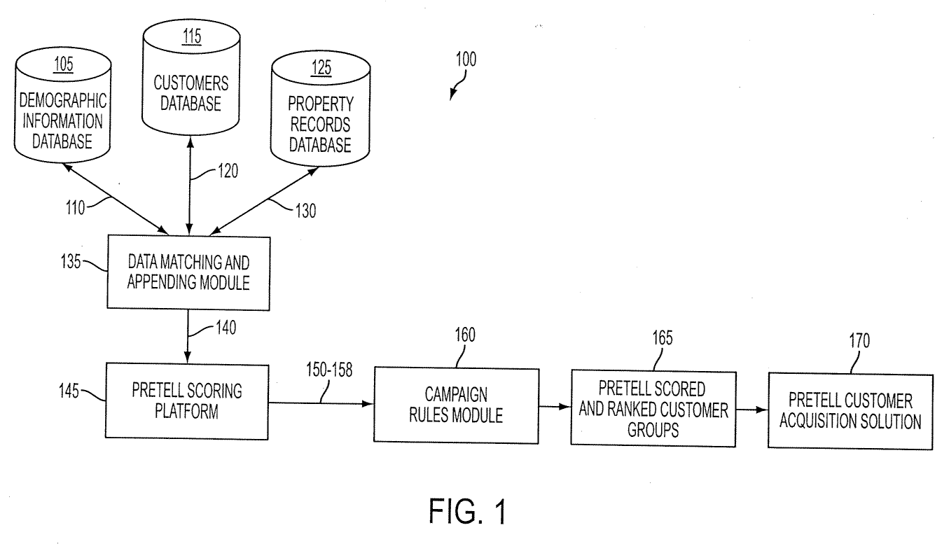

FIG. 1 is a block diagram of a scoring system 100 that calculates and outputs scores to assist marketing individuals in directed marketing efforts to acquire mortgage customers according to an embodiment of the invention. The scoring system 100 may include one or more databases, for example, a demographic information database 105, a customer database 115, and a property records database 125. For illustrative purposes, three databases are depicted in FIG. 1; however, other embodiments are possible which include any number of databases.

The demographic information database 105 includes demographic data 110 about a customer. The customer may be a credit card customer, a demand deposit account customer, a bank customer, an auto loan customer, a brokerage customer, an investment customer, etc. The demographic data 110 may be an input file provided by a third party provider such as Acxiom Corporation. The demographic data 110 may include the age of the head of household, the race of the head of household, the number of children, the household income, the average home price in the area, and the number of credit cards issued to the head of household.

The customer database 110 includes customer data 120 about the customer. The customer data 120 may be an input file provided by any third party provider. The customer data includes name and address information.

The property records database 125 includes property data 130 about the customer's property. The property data 130 may be an input file provided by a third party provider such as First American Real Estate Solutions. The property data 130 may include the customer's name and address, the number of bedrooms and bathrooms of the property, the lot size of the property, the square footage of the property, the appraisal amount of the property, the liens (e.g., first and second) on the property, all historical transactions related to that specific property owner, the dates of those transactions, the type of loan, the institution originating the loan, the original loan balance, and other loan-specific information where available.

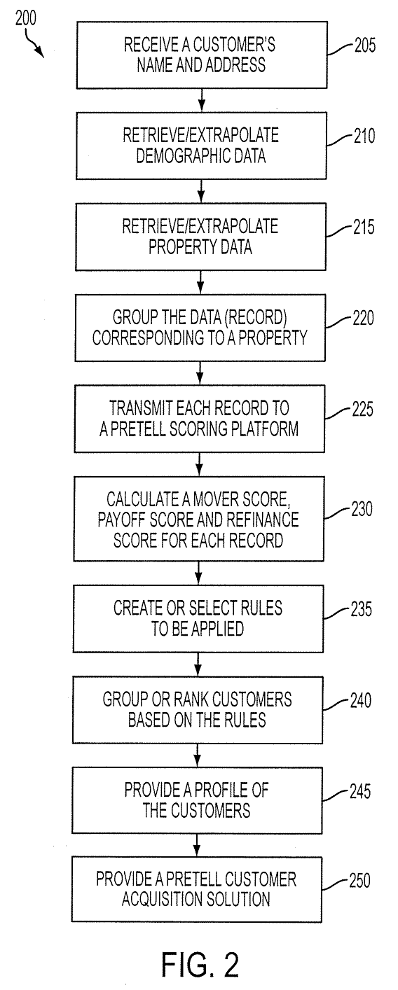

FIG. 2 is a flow chart of a method 200 of determining and grouping individuals that are more likely to move, payoff or refinance their mortgages according to an embodiment of the invention. Referring to FIGS. 1 and 2, the scoring system 100 includes a data matching and appending module 135. In one embodiment, the data and appending module 135 receives only the customer's name and address (205). The data and appending module 135 may retrieve and/or extrapolate the demographic data 110 corresponding to the customer's name and address from the demographic information database 105 (210) and retrieve and/or extrapolate the property data 130 corresponding to the customer's name and address from the property records database 125 (215). For example, the property data 130 may include the date the home was purchased but not the interest rate. The data matching and appending module 135 may use the date of purchase to determine what the current interest rates were at the time the home was purchased or refinanced to add more information to the property data 130. For example, the data matching and appending module 135 may search a rate table to determine a rate at a time the home was purchased or refinanced. Using the demographic data 110, the customer data 120 and/or the property data 130, the data matching and appending module 135 may extrapolate or retrieve information to fill in missing property data 130.

The data matching and appending module 135 appends or groups the data corresponding to the same person together to form a record 140 (220). Each record 140 includes the demographic data 110, the customer data 120, and the property data 130 for a particular person. Each record 140 is transmitted to a pretell scoring platform 145 (225).

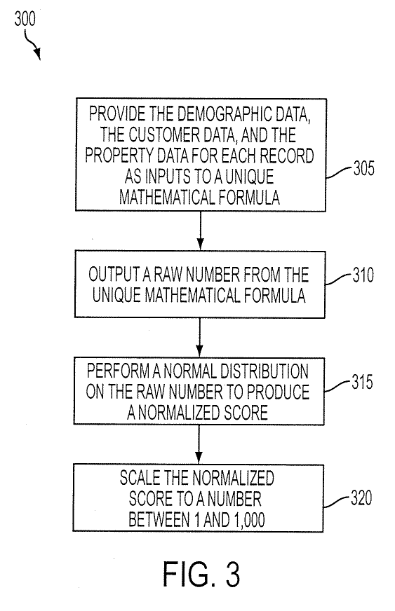

The pretell scoring platform 145 uses the demographic data 110, the customer data 120, and the property data 130 to calculate a mover score 150, a payoff score 151 and a refinance score 152 for each record 140 (230). FIG. 3 is a flow chart of a method 400 of calculating a mover score, a payoff score and a refinance score according to an embodiment of the invention. In one embodiment, the pretell scoring platform 145 provides the demographic data 110, the customer data 120, and the property data 130 for each record as inputs to a unique mathematical formula (305). Each model has a different mathematical formula that emphasizes (i.e., weights) the different inputs. The unique mathematical formula outputs a raw number, for example, between −1 and 6.2 (310). The pretell scoring platform 145 performs a normal distribution on the raw number to produce a normalized score (315). The normalized score value may be calculated using the following formula: normalized score value =1000+100(B₀+B₁z)/ln(2), where B₀ and B₁ are parameter estimates and z is the raw number. B₀ and B₁ are different for each model. The normalized score is scaled to a number between 1 and 1,000 to produce a numeric score (320). The numeric score is unique to each model (e.g., the mover score 150, the payoff score 151, and the refinance score 152) and is based on the demographic data 110, the customer data 120, and the property data 130. Hence, each raw score is transformed, normalized and standardized so that the respective score ranges in value from 0 to 1,000. Table I shows how the normalization process converts the raw score value to a normalized score ranging in value from 0 to 1000.

TABLE I

| Score (S) | Rate | Probability (p) | Odds |
|---|---|---|---|
| 1,000 | ½ | 0.50000 | 1:1 |
| 900 | ⅓ | 0.33333 | 1:2 |
| 800 | ⅕ | 0.20000 | 1:4 |
| 700 | 1/9 | 0.11111 | 1:8 |
| 600 | 1/17 | 0.05882 | 1:16 |
| 500 | 1/33 | 0.03030 | 1:32 |
| 400 | 1/65 | 0.01538 | 1:64 |
| 300 | 1/129 | 0.00775 | 1:128 |
| 200 | 1/257 | 0.00389 | 1:256 |
| 100 | 1/513 | 0.00195 | 1:512 |
| 0 | 1/1025 | 0.00098 | 1:1024 |

The mover score 150, the payoff score 151, and the refinance score 152 are used for targeted marketing campaigns.

The mover score 150 is a measure of the borrower's propensity to move within a specified time period from the particular property owned by the customer. The specified time period may be 1 month, 3 months, 6 months, 9 months, or 12 months. The payoff score 151 is a measure of the customer's propensity to payoff the entire loan amount for the particular property within the specified time period. The refinance score 152 is a measure of the customer's propensity to refinance the particular property owned by the customer within the specified time period. In one embodiment, the mover score 150, the payoff score 151 and the refinance score 152 are numbers between 1 and 1,000. The lower the number, the less likely the customer is going to move, payoff or refinance and the higher the number, the more likely the customer is going to move, payoff or refinance. A mover, payoff or refinance score of 100, for example, means that the customer is not likely to move, payoff or refinance within the next 6 months. On the other hand, a mover, payoff or refinance score of 900, for example, means that the customer is likely to move, payoff or refinance within the next 6 months. The mover score 150, the payoff score 151 and the refinance score 152 can be low numbers, middle numbers, high numbers or combinations thereof.

The pretell scoring platform 145 may also calculate a national average mover score 153, a regional average mover score 154, a national average payoff score 155, a regional average payoff score 156, a national average refinance score 157, and a regional average refinance score 158. These scores are calculated as loan amount based dollar-weighted averages for each respective region/segment. The region may be defined as a city, a county, or a state, or may include a number of cities, counties, or states.

The pretell scoring platform 145 may also calculate a sensitivity measure (a.k.a. volatility score) for each product type. The volatility of a customer can be determined by the sensitivity measure. The sensitivity measure is the customer's score sensitivity to a basis point, for example, 50 basis points (½ percentage point), increase or decrease in interest rates. The sensitivity measure is calculated based on the changes in score value when interest rates (e.g., the 1-year and 10 -year Treasury rates) are reduced by a basis point. The sensitivity measure allows one to compare which customers are most sensitive to movements in interest rates amongst all customers with equivalent or similar score values.

The mover score 150, the payoff score 151, the refinance score 152 and sensitivity measure may be product specific. That is, a different score may be provided for each product type. The different product types are provided in FIG. 7. Since there are 4 product types and 3 different scores, a total of 12 unique scores may be calculated by the pretell scoring platform 145.

The scoring system 100 includes a campaign rules module 160 that includes rules 162 that can be applied based on the mover score 150, the payoff score 151, the refinance score 152, the national average mover score 153, the regional average mover score 154, the national average payoff score 155, the regional average payoff score 156, the national average refinance score 157, and the regional average refinance score 158. The rules may be created or selected by a marketing individual or team depending on the desired target group (235).

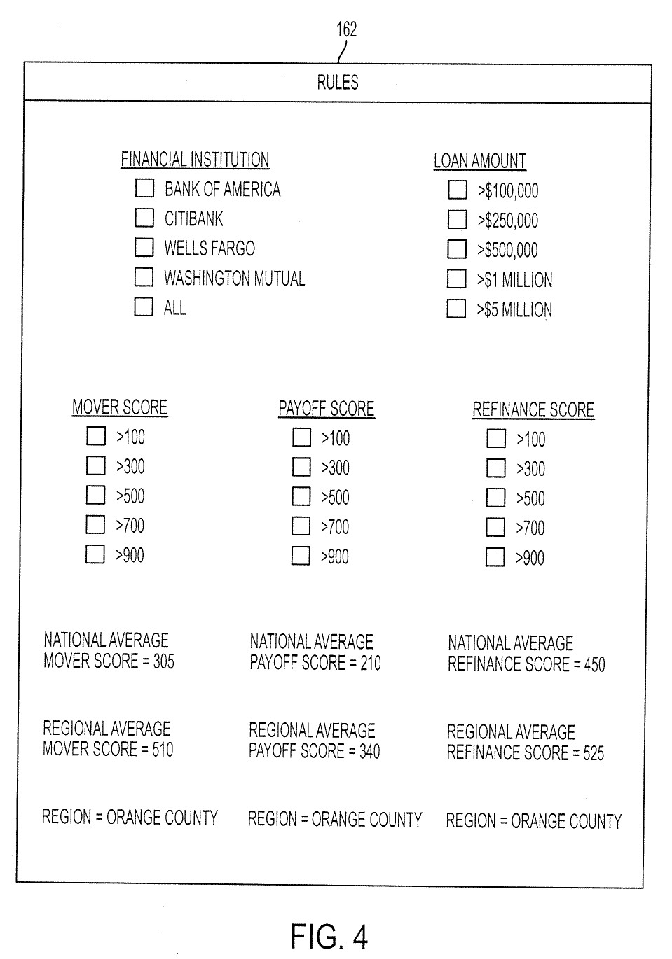

FIG. 4 is a graphical user interface that displays rules 162 and allows the user to select the rules 162 to obtain a desired group of individuals to target according to an embodiment of the invention. The rules 162 may include a financial institution name, a demographic characteristic, a geographic region, an income range, a loan amount, a mover score, a payoff score, a refinance score, etc. For example, the user via the rules 162 may want to target Wells Fargo borrowers that have loans greater than $500,000 and a refinance score of greater than 700.

The scoring system 100 calculates and displays the national average mover score 154, the national average payoff score 156 and the national average refinance score 158. Once the region is selected, the scoring system 100 calculates and displays the regional average mover score 154, the regional average payoff score 156 and the regional average refinance score 158.

Referring back to FIGS. 1 and 2, the scoring system 100 may include a pretell scored and ranked customer groups module 165 that groups or ranks customers based on the created or selected rules 162 (240). For example, the pretell scored and ranked customer groups module 165 may group the customers with the greatest likelihood of moving, paying off or refinancing at the top of the list. The groups can be listed in a variety of different ways depending on the user's preferences. For example, the pretell scored and ranked customer groups module 165 can provide a profile (e.g., demographic, geographic or income profile) of the customers (245). The pretell scored and ranked customer groups module 165 can provide the results in the form of a pretell customer acquisition solution 170 (250). The pretell customer retention solution 170 can be a graph, chart, table, etc. showing the target group of customers.

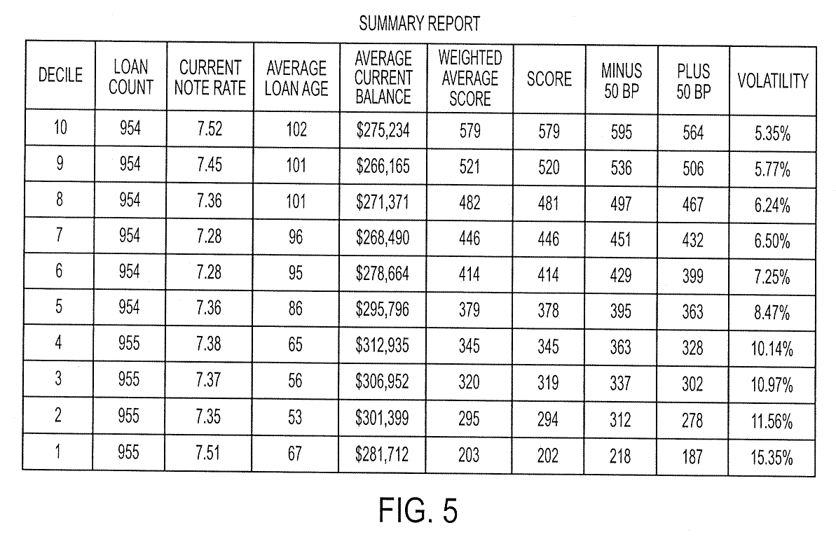

FIG. 5 is a table of the pretell customer retention solution 170 according to an embodiment of the invention. The table is a summary report that presents the results of the scoring process by sorting the scores into deciles. The scores (e.g., weighted average score and score) listed in the table can be the mover score, the payoff score or the refinance score. The score provides an accurate measure of the likelihood that the customer will move, payoff or refinance their home. The score also provides a historical perspective on the expected overall level of prepayment activity that is projected to occur over the next 6 months. The highest decile (10) includes customers that have a weighted average score of 579. The business should have aggressive marketing efforts towards these customers. The lowest decile (1) includes customers that have a weighted average score of 203. The business should have no marketing efforts towards these customers. Depending on which score is listed, the business can determine the customers that are most likely going to move, payoff their loans or refinance their loans.

The table also shows a minus 50 basis point score, a plus 50 basis point score, and a volatility score. The customers that have the higher volatility scores are more likely to move, payoff or refinance when rates increase or decrease. The customer acquisition solution allows the business to prioritize the customers based on the score (e.g., mover, payoff or refinance) and the volatility score.

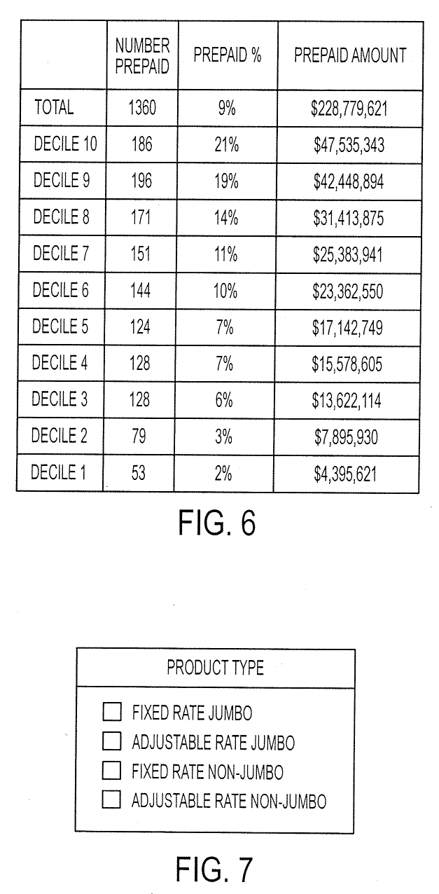

FIG. 6 is a table showing that the deciles shown in FIG. 5 with the highest scores have the highest propensity to move, payoff or refinance their loans according to an embodiment of the invention. The percentage of payoff for decile 10 (21%) is much greater than the payoff percentage for decile 1 (2%).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. The method can be implemented in hardware, software, or a combination of hardware and software using a personal computer, server, or other processor based system. Those skilled in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. A machine-readable medium embodying a method of providing a list of individuals who are most likely to move, payoff or refinance their mortgages, the method comprising:
receiving a name and an address from a customer database;
retrieving demographic data corresponding to the name and the address from a demographic information database;
extrapolating property data corresponding to the name and the address from a property records database;
creating a plurality of records, each record including the name, the address, the demographic data and the property data;
calculating a propensity score for each of the plurality of records;
determining rules that relate to the propensity scores; and
applying the rules to each of the plurality of records to form a target list.

2. The method of claim 1 wherein each propensity score is selected from a group consisting of a mover score, a payoff score, a refinance score, and combinations thereof.

3. The method of claim 1 wherein each propensity score is calculated using the demographic data, the customer data, and the property data.

4. The method of claim 1 wherein the rules are selected from a group consisting of a financial institution name, a demographic characteristic, a geographic region, an income range, a loan amount, a mover score, a payoff score, a refinance score, and combinations thereof.

5. The method of claim 1 wherein the demographic data is selected from a group consisting of an age of the head of household, a race of the head of household, a number of children, a household income, an average home price in the area, a number of credit cards issued to the head of household, and combinations thereof.

6. The method of claim 1 wherein extrapolating property data corresponding to the name and the address from a property records database includes searching a rate table to determine a rate at a time the property was purchased.

7. The method of claim 1 wherein extrapolating property data corresponding to the name and the address from a property records database includes searching a rate table to determine a rate at a time the property was refinanced.

8. The method of claim 1 wherein the property data is selected from a group consisting of a borrower's name and address, a number of bedrooms and bathrooms of the property, a lot size of the property, a square footage of the property, an appraisal amount of the property, a lien on the property, and combinations thereof.

9. A machine-readable medium embodying a method of providing a list of individuals who are most likely to move, payoff or refinance their mortgages, the method comprising:
receiving a name and an address from a customer database;
retrieving demographic data corresponding to the name and the address from a demographic information database;
extrapolating property data corresponding to the name and the address from a property records database;
creating a plurality of records, each record including the name, the address, the demographic data and the property data;
calculating a propensity score and a sensitivity measure for each of the plurality of records; and
forming a target list from the plurality of records using the propensity score and the sensitivity measure.

10. The method of claim 9 wherein the demographic data is selected from a group consisting of an age of the head of household, a race of the head of household, a number of children, a household income, an average home price in the area, a number of credit cards issued to the head of household, and combinations thereof.

11. The method of claim 9 wherein the property data is selected from a group consisting of a borrower's name and address, a number of bedrooms and bathrooms of the property, a lot size of the property, a square footage of the property, an appraisal amount of the property, a lien on the property, and combinations thereof.

12. The method of claim 9 wherein the sensitivity measure is a customer's score sensitivity to a basis point increase or decrease in interest rates.

13. An apparatus for providing a list of individuals who are most likely to move, payoff or refinance their mortgages, the apparatus comprising:
a database for storing demographic data, customer data and property data;
a data matching and appending module for receiving a name and an address from the database, retrieving demographic data corresponding to the name and the address from the database, extrapolating property data corresponding to the name and the address from the database, and creating a plurality of records, each record including the name, the address, the demographic data and the property data;
a scoring module for calculating a propensity score for each record;
a rules module for determining rules that relate to the propensity scores; and
a group module for applying the rules to each record to form a target list.

14. The apparatus of claim 13 wherein each propensity score is selected from a group consisting of a mover score, a payoff score, a refinance score, and combinations thereof.

15. The apparatus of claim 13 wherein each propensity score is calculated using the demographic data, the customer data, and the property data.

16. The apparatus of claim 13 wherein the rules are selected from a group consisting of a financial institution name, a demographic characteristic, a geographic region, an income range, a loan amount, a mover score, a payoff score, a refinance score, and combinations thereof.

17. The apparatus of claim 13 wherein the demographic data is selected from a group consisting of an age of the head of household, a race of the head of household, a number of children, a household income, an average home price in the area, a number of credit cards issued to the head of household, and combinations thereof.

18. The apparatus of claim 13 wherein extrapolating property data corresponding to the name and the address from a property records database includes searching a rate table to determine a rate at a time the property was purchased.

19. The apparatus of claim 13 wherein extrapolating property data corresponding to the name and the address from a property records database includes searching a rate table to determine a rate at a time the property was refinanced.

20. The apparatus of claim 13 wherein the property data is selected from a group consisting of a borrower's name and address, a number of bedrooms and bathrooms of the property, a lot size of the property, a square footage of the property, an appraisal amount of the property, a lien on the property, and combinations thereof.
